(19) United States
(12) Patent Application Publication
(10) Pub. No.: US 2020/0302099 A1
(43) Pub. Date: Sep. 24, 2020

(54) SYSTEM AND METHOD OF MACHINE LEARNING-BASED DESIGN AND MANUFACTURE OF EAR-DWELLING DEVICES

(71) Applicant: Lantos Technologies, Inc., Wilmington, MA (US)

(72) Inventors: John Gerard Grenier, Jamaica Plain, MA (US); Patrick G. Heck, Needham, MA (US); Lydia Gregoret, Concord, MA (US); Xiaowei Chen, Lexington, MA (US); Joseph O. St. Cyr, Salem, NH (US); David Mackey, Concord, MA (US)

(21) Appl. No.: 16/825,358

(22) Filed: Mar. 20, 2020

Related U.S. Application Data
(60) Provisional application No. 62/822,590, filed on Mar. 22, 2019.

(51) Int. Cl. G06F 30/27; H04R 25/00; G06F 30/12

(52) U.S. Cl. CPC G06F 30/27; G06F 2113/22; G06F 30/12; H04R 25/659

(57) ABSTRACT

A computer-implemented method to create a model used for fabrication of a device configured for placement in an anatomical cavity of a wearer may include first selecting training data and/or testing data by obtaining feedback and data for a plurality of devices fabricated for a plurality of subjects, wherein each of the plurality of devices are fabricated based on a three-dimensional scan of an anatomical cavity of one of the plurality of subjects. The training data set is used to train a machine learning model for transforming a three-dimensional scan of an anatomical cavity to a three-dimensional representation of a device for fabrication.

### CLAIM TO PRIORITY

This application claims the benefit of the following provisional application, which is hereby incorporated by reference in its entirety: U.S. Ser. No. 62/822,590, filed Mar. 22, 2019 (LANT-0501-P01).

### BACKGROUND

### Field

The present disclosure relates to machine learning based design of cavity dwelling devices.

### Description of the Related Art

Generating a custom cavity-dwelling device can be time consuming as an initial three-dimensional scan has traditionally been manually processed to generate a three-dimensional design for a device. Further, since the process is manual, human error cannot be avoided and optimal design may only be identified after fabrication is complete. There remains a need for an automated process for custom cavity-dwelling device design that avoids human error and results in an optimal, or near optimal, design.

### SUMMARY

In an aspect, a computer-implemented method to create a model used for fabrication of a device configured for placement in an anatomical cavity of a wearer, the method including (a) obtaining feedback data for a plurality of devices fabricated for a plurality of subjects, wherein each of the plurality of devices are fabricated based on a three-dimensional scan of an anatomical cavity of one of the plurality of subjects, and wherein the feedback data relates to at least one of a user experience, a fit, a comfort, and a performance of the plurality of devices; (b) utilizing the feedback data to select a training data set for a model for transforming a three-dimensional scan of an anatomical cavity to a three-dimensional representation of a device for fabrication; (c) training the model with the training data set, wherein the training data set comprises paired devices and three-dimensional scans; (d) obtaining a three-dimensional scan of an anatomical cavity of a wearer and at least one parameter for a device; and (e) transforming the three-dimensional scan into a three-dimensional representation of the device for fabrication in accordance with the model and the at least one parameter. Transforming at least one of adds dimension or reduces dimension of a portion of the three-dimensional scan. The model may be a neural network. The anatomical cavity may be an ear. The device may be an in-ear device. The feedback data may be further utilized to select a testing data set for the model, and further testing the model with the testing data set. The three-dimensional scan may be in a first format and is converted to a second format to do modeling. At the completion of modeling, the resulting three-dimensional representation may be converted back to the first format prior to fabrication. The three-dimensional representation may be an STL file.

In an aspect, a computer-implemented method for fabrication of a device configured for placement in an anatomical cavity of a wearer may include (a) obtaining feedback data for a plurality of devices worn by subjects, the feedback data relating to at least one of a user experience, a fit, a comfort, and a performance of the plurality of devices; (b) training a model with a dataset selected based on the feedback data; (c) obtaining a three-dimensional scan of the anatomical cavity of a wearer; (d) transforming the three-dimensional scan in accordance with the model and at least one parameter for a device into a modified scan; and (e) providing the modified scan to a fabricator to fabricate the device based on the modified scan.

In an aspect, a system to fabricate a custom device to be worn in an anatomical cavity of a wearer may include a processor that: (i) trains a machine learning model on datasets selected based on feedback data for a plurality of devices worn by subjects, the feedback relating to a user experience, a fit, a comfort, or a performance of the plurality of devices; (ii) receives at least one parameter for the custom device; and (iii) receives a three-dimensional scan of the anatomical cavity of a wearer, the processor further comprising stored instructions that when executed cause the processor to: generate modifications of the three-dimensional scan to obtain a modified scan, wherein the modifications of the three-dimensional scan are in accordance with the machine learning model and wherein the modifications comprise at least one of adding or reducing dimension of the three-dimensional scan. The processor may be further programmed to send the modified scan to a fabricator for the fabrication of the custom device. The system may further include a user interface to provide input to the system. A fabricator may fabricate the custom device based on the modified scan. The anatomical cavity of the wearer may be an ear. The custom device may be an in-ear device.

In an aspect, a method to fabricate and deliver a custom device to be worn in an anatomical cavity of a wearer may include (a) providing a three-dimensional scanner configured to scan the anatomical cavity of a wearer; (b) providing an order interface to a user, wherein the order interface provides the user with an option to select a device type; (c) based on the device type, obtaining a three-dimensional scan for the anatomical cavity of the wearer from the three-dimensional scanner; (d) modifying the scan based on a model previously trained on data related to at least one of a fit, a comfort, or a performance of similar devices in similar anatomical cavities of subjects; and (e) providing the modified scan to a fabricator for fabrication and delivery of the custom device to at least one of the user or wearer.

In an aspect a computer-implemented method to determine a device design for placement in a cavity may include (a) obtaining feedback data from a user for a device, wherein the feedback data relates to at least one of a user experience, a fit, a comfort, and a performance of the device; (b) obtaining a three-dimensional scan of an anatomical cavity of the user; (c) generating a training vector, wherein the training vector includes: the feedback data, the three-dimensional scan, and an identification of the device; (d) training a model using the training vector; (e) obtaining three-dimensional scans of an anatomical cavity of a second user; (f) providing the three-dimensional scan of the anatomical cavity of the second user to the model; and (g) receiving, from the model, data indicative of a selected design of a device for the second user. In some cases, training the model further comprises training the model using a plurality of training vectors corresponding to feedback data and three dimensional scans from a plurality of users.

In an aspect, a computer-implemented method to determine a device design for placement in a cavity may include (a) obtaining a three-dimensional scan of an anatomical cavity of a user; (b) obtaining a three-dimensional data of a device that is placed in the anatomical cavity of the user; (c) obtaining feedback data from a user for a device, wherein the feedback data relates to at least one of a user experience, a fit, a comfort, and a performance of the device; (d) generating a training vector, wherein the training vector includes: the feedback data, the three-dimensional scan, and the three-dimensional data of the device; (e) training a model using the training vector; (f) obtaining a three-dimensional scan of an anatomical cavity of a second user; (g) obtaining a design data of base device design; (h) receive a modification to the base device design; (i) providing to the model: the three-dimensional scan of the anatomical cavity of the second user to the model, data representative of the base device design, and the modification to the base device design; and (j) receiving, from the model, data indicative of a predictive rating of the modification to the base device design for the second user.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 is a screenshot of a system for designing an ear-dwelling device.

FIG. 2 is a screenshot of a system for designing an ear-dwelling device.

FIGS. 3A, 3B, and 3C are screenshots of a system for designing an ear-dwelling device.

FIGS. 4A and 4B are screenshots of a system for designing an ear-dwelling device.

FIG. 5 is a screenshot of a system for designing an ear-dwelling device.

FIG. 6 depicts a method of a machine learning model.

FIG. 7 depicts a method of a machine learning model.

FIG. 8 depicts a system for fabrication of devices designed by a machine learning model based on a cavity scan.

FIG. 9 depicts a method of a machine learning model.

### DETAILED DESCRIPTION

In an aspect, the design and manufacture of cavity-dwelling devices, such as ear-dwelling devices, may be machine learning-based. Characteristics of ear-dwelling devices, such as for example, hearing aids, may be determined and/or optimized using machine learning. It is to be understood that while descriptions herein may relate to hearing aids, the methods and systems described herein are not limited to hearing aids and may be applied to various cavity-dwelling devices that may be placed in the ear, mouth, and the like.

In some embodiments, the design of a hearing aid may be customized to each person. A hearing aid may be formed and adapted to a person's unique physiology, such as ear canal shape. A hearing aid may be automatically or at least partially automatically adapted to a person's ear canal shape by forming, shaping, and/or configuring the hearing aid based on at least in part on a scan of a person's ear. In some embodiments, a hearing aid may be formed to fit the exact shape and dimensions of the scan of the ear cavity. However, in many instances, direct matching of the shape of a device to a scan of an ear cavity may not provide the best comfort, performance, satisfaction, feel, experience, and the like to the person wearing the hearing aid. In some instances, the fit and performance of a hearing aid may be improved when the shape and design of the hearing aid deviate from the exact shape of the scanned ear cavity. For example, in some cases, a user wearing a device may experience improved comfort when the size of the hearing aid is smaller than the scanned dimensions of the cavity in some locations and larger than the scanned dimension of the cavity in other locations. In another example, forming a hearing aid to the exact dimensions of a scanned cavity may cause discomfort to some users during movement, such as earing or yawning which may cause a distortion of the ear cavity.

In practice, a single design criteria of hearing aid shape and design with respect to a shape of ear cavity may fail to provide satisfactory performance, fit, comfort, and the like to the person using the hearing aid. The fit, comfort, performance, and the like may depend on a very large number of variables that may be related to the shape of a person's ear cavity. In embodiments, different shapes, curvatures, absolute dimensions, relative dimensions, depth, and the like of an ear cavity may warrant different choices with respect to the shape, size, curvature, materials, textures, flexibility, and the like of hearing aid to achieve a good fit and performance. Further complicating the matter is the aspect that many aspects of fit performance may be subjective to a user and difficult to determine which aspect of design causes the perception of comfort or preferred fit for the user. A large number of variations associated with a person's ear cavity and the large number of design choices for a device make selecting an appropriate design for a particular person impossible using traditional methods.

In embodiments, computer algorithms and/or models may be trained and/or created to analyze and/or determine appropriate characteristics of hearing aid for a particular person. Computer algorithms and/or models may be trained and/or created to determine and/or optimize characteristics of a hearing aid based on a scan of an ear cavity of a person. In embodiments, computer algorithms may be trained to automatically or semi-automatically determine characteristics of a hearing aid, the determined characteristics may include at least one of a: shape, size, relative size, relative shape, curvature, texture, flexibility, materials, length, weight, power output, frequency response, and the like.

In some embodiments, the design and manufacture of cavity-dwelling devices, such as ear-dwelling devices may be based on neural networks and neural network training. Neural network training proceeds by taking initial conditions, then calculating a prospective transformation, comparing that to a reference (e.g., the positive data or good result) and then propagating the errors (e.g. the differences from the ideal) back into the network so that next time the prospective transformation is somewhat closer.

Data from past cavity scans, devices and conventionally-generated three-dimensional models and/or customer feedback about devices may be collected with the object of identifying a plurality of datasets including initial three-dimensional scans and three-dimensional representations, or design models, that were good results or resulted in positive data for a final product, such as positive data for one or more of performance, fit, comfort, cost, reliability, manufacturability, or appearance. The plurality of datasets may be selected based on positive data associated with the end resulting device and may be used to train the machine learning model and validate the machine learning model.

Selecting training data to use for machine learning may be done through a user experience survey, which enables selecting paired before and after shapes that rated highly. Selecting training data to use for machine learning may be done through an automated visual inspection data of fit, which enables selecting paired before and after shapes that fit well. Selecting training data to use for machine learning may be done through automated audio feedback of an ear-dwelling device once placed in the ear, which enables selecting paired before and after shapes that performed well acoustically.

Any number of machine learning algorithms may be used in the system, such as linear regression algorithms, regularized linear regression algorithms, decision tree algorithms, subtypes of any of the algorithms thereof, and the like. For example, a machine learning/deep learning algorithm may process the training data and learn the transformations from scans to devices in order to generate one or more predictive models that can take initial scans and output a three-dimensional model for a device by mimicking the transformation from scan to model. In an aspect, the plurality of datasets may be for one device type only so that the machine learning model is limited to predicting design models for only one device type. In another aspect, the plurality of datasets comprise multiple device types so that the machine learning model learns a more generalized transformation from scans to design models for many device types. In an aspect, prior to initiating the algorithm to train, certain parameters may be set, such as the number of trees to include in a random forest of decision trees.

In another aspect, the predictive model may comprise a series of attributes that are learned from the training data, such as regression coefficients, decision tree split locations, and the like. For example, the ear may jut during a scan, and through machine learning, a learned attribute may be where to recess the predicted model in areas where the ear jutted during scan (e.g. tragus, anti-tragus). In another example, a learned attribute may be where to expand the model in areas for a tighter fit or better seal dependent on the application (e.g. the canal from aperture through completion of first bend of the ear canal).

In an aspect, a machine learning model may be trained to generate designs that exhibit good performance. For example, in an industrial application, this may mean generating predicted models of ear-dwelling devices with a tighter fit in the ear. For music applications (e.g. consumer earpieces, stage monitors, etc.), this may mean generating predicted models of ear-dwelling devices with an enhanced frequency range. For a hearing aid, this may mean generating predicted models of ear-dwelling devices with a limited frequency range. Ear bud tips/adapters may yet have other criteria for exhibiting good performance that may be learned by a machine learning model.

In an aspect, a machine learning model may be trained to generate designs that exhibit good comfort. For example, a machine learning model may learn where to cut off reach of the three-dimensional model relative to the second bend of the ear canal to ensure comfort. In another example, the machine learning model may learn where to taper the 3-D model into the canal for a comfort fit.

The performance, robustness, and consistency of the final trained machine learning model may be validated on data from the plurality of datasets that were not used as training data. Training may continue until a point is met, such as a minimum validation error, a validation criteria, a threshold % identity between predicted design and actual design from the test data, or the like.

In an aspect, the trained machine learning model may be deployed and accessible in any computer-implemented manner, such as by user interface, API, or any software, program codes, and/or instructions on a processor.

In an aspect, the system may receive a scan as input, such as a scan of an ear or other cavity of a user. The device type or other device details may be input so that the appropriate machine learning model is selected. Then, the scan is transformed in accordance with the machine learning model to generate a predicted model (a.k.a. a three-dimensional representation or a design) for a device. In an aspect, the predicted model may be evaluated prior to manufacturing, such as in cases where input data re of low quality or if device parameters selected are inadvisable given the input data (e.g. adult device selected for a child's ear). In embodiments, before the predicted model is even generated, the process may be halted if the device parameters selected are inadvisable given the input data. The design may then be used as the basis for manufacturing a device. Once complete, the user is sent the device. Feedback data on the device may be used to determine if further training of the machine learning model is needed, and if the scan and design for the device should be used as training data.

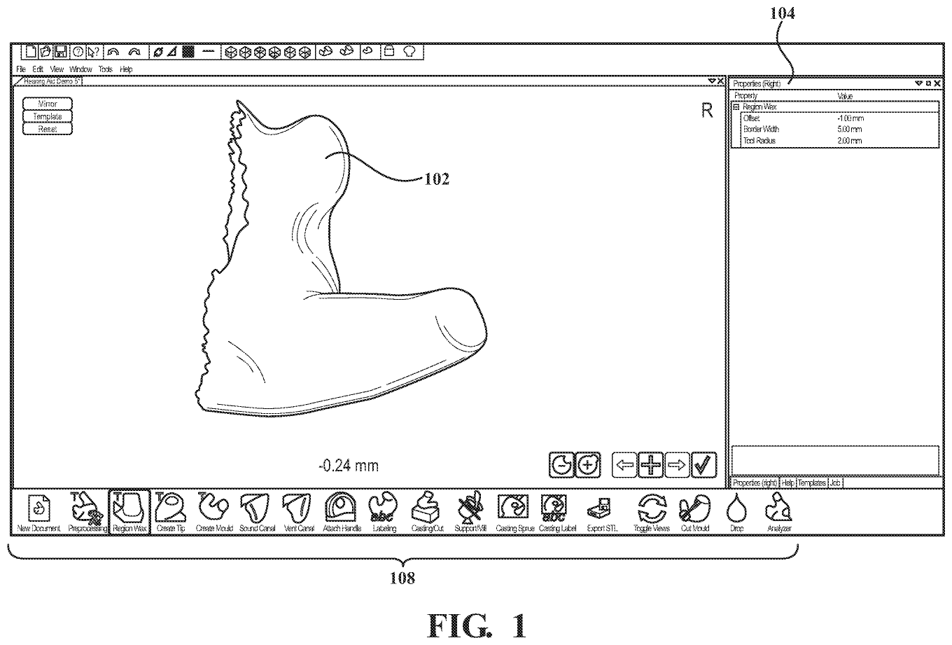

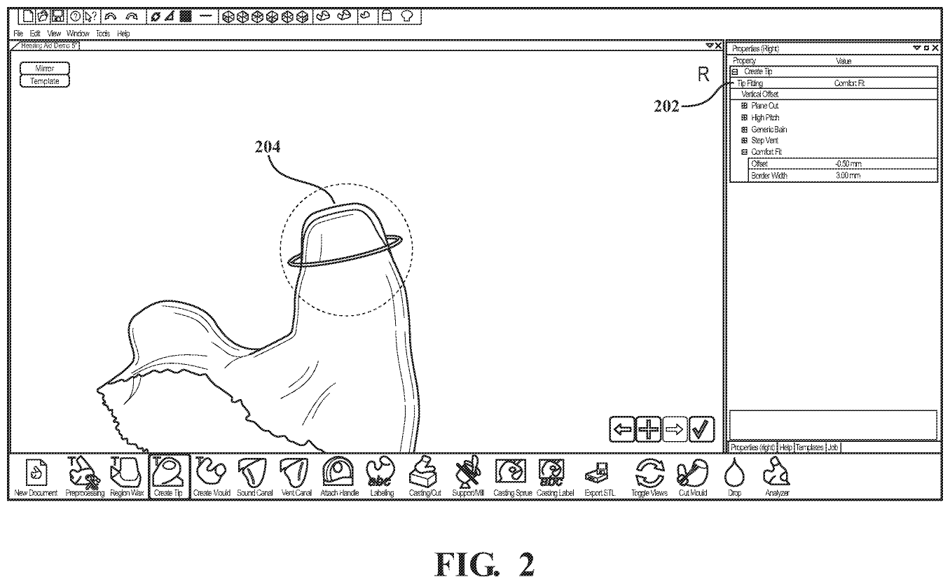

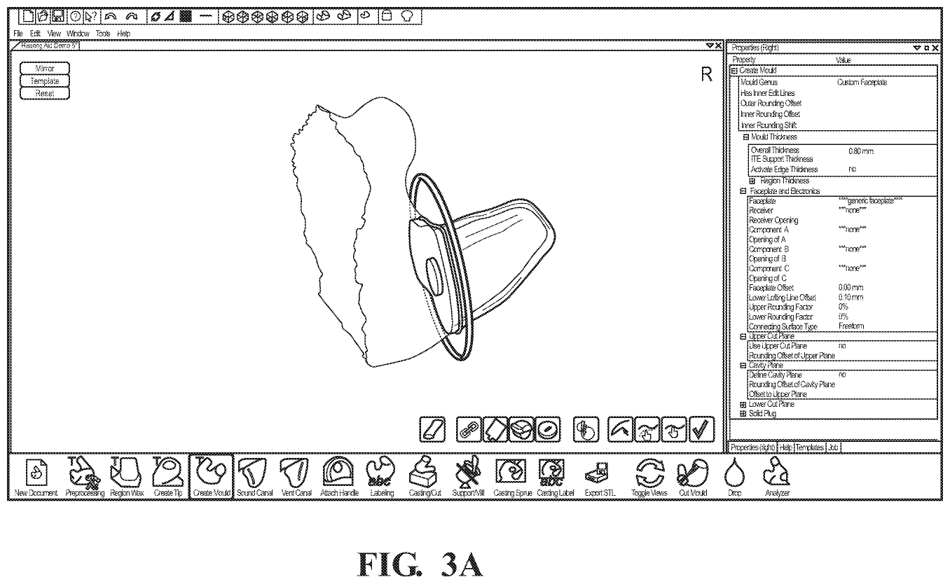

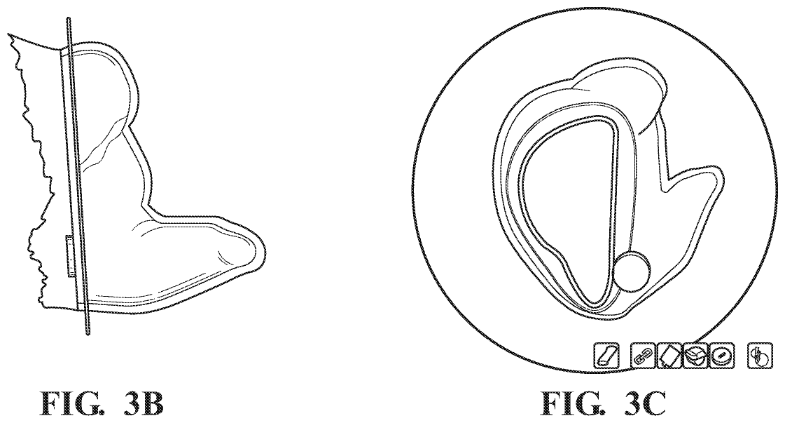

As described above, data from past cavity scans, devices and three-dimensional models and/or customer feedback about devices may be collected with the object of identifying training data and test data. FIGS. 1-5 depict certain steps of processes for conventionally generating three-dimensional models, or designs, based on cavity scans. Referring to FIG. 1, a screenshot of a user interface for designing an ear-dwelling device, in this case a hearing aid, is shown. Based on an initial three-dimensional scan of a cavity, which in this example is an ear, a three-dimensional representation 102 of the cavity is depicted. FIGS. 1, 2, and 3A-3C depict manipulation of a 3-D representation 102 to generate a design for the ear-dwelling device. Various tools and functions 108 are possible through the user interface for manipulating the three-dimensional representation 102, including pre-processing, region waxing, creating a tip, creating a mold, forming a sound canal, forming a vent canal, attaching a handle, labeling, casting, cutting, supporting, mulling, placement of casting sprues, casting label, exporting a file, toggling a view, cutting the mould, drop, analyzer, mirror views, template view, view manipulation of the representation 102, and the like. In the view shown in FIG. 1, the representation 102 is being region waxed in accordance with properties shown in a box 104 on the right, such as offset, border width, and tool radius. FIG. 2 is a screenshot of a subsequent phase of manipulation of the representation 102, in this case creating a tip 204. A tip fitting parameter 202 may be selected through the user interface, such as a comfort fit, a performance fit, a tight fit, or the like. FIGS. 3A, 3B, and 3C depict succeeding mould creation manipulations of the representation 102 to incorporate a faceplate and electronics.

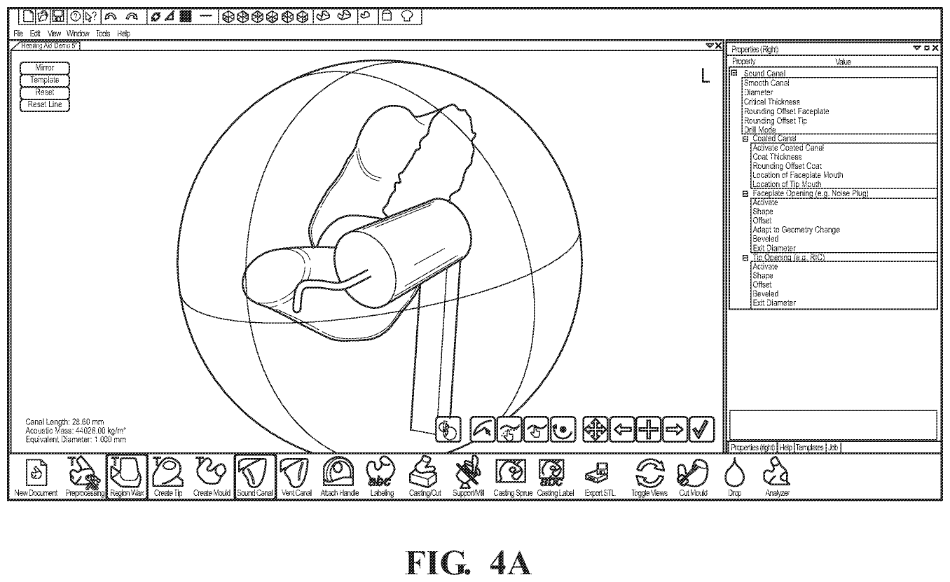

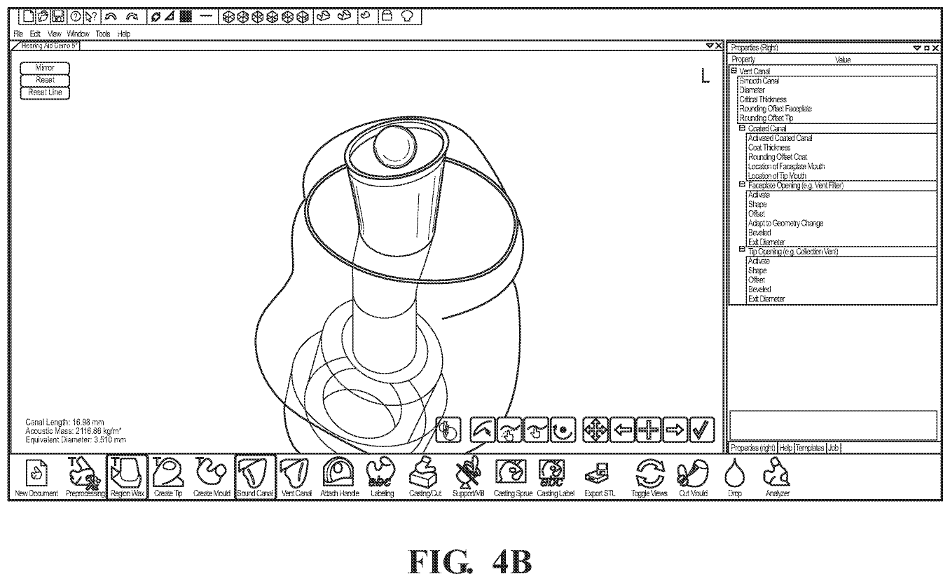

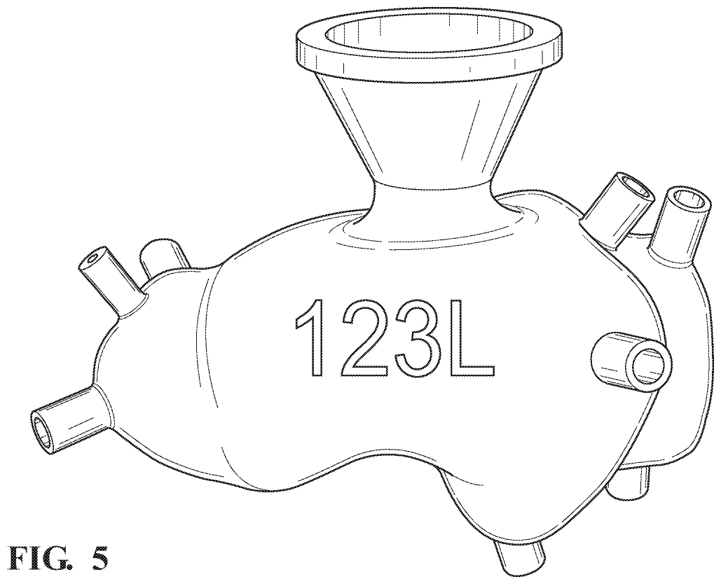

Referring now to FIGS. 4A and 4B, a different representation than that shown in FIG. 1 is being manipulated in FIG. 4A to add a sound canal and in FIG. 4B to add a vent canal. FIG. 5 depicts the final design after placement of casting sprues and a custom label.

In an aspect, the various tools and functions 104 described with respect to FIGS. 1-5 may be embodied in the transformations carried out by the machine learning model. The machine learning model may transform scan data to a predicted model, which may result in modifying the overall shape and appearance of the 3-D representation of a cavity to generate an appropriate final shape for a device to dwell in the cavity. This shape-to-shape transformation may include modifications such as scalloping, shaping, contouring, dimpling, shortening/trimming, lengthening, tapering, waxing, adding dimension, reducing dimension of at least a portion, or the like. Other modifications may include colors, finishes, decorative/aesthetic changes, or other changes according to user preference. The modification made may account for a volume needed to accommodate certain other components/technology. In some embodiments, the modifications may include adding additional components at particular, learned positions and extending portions of the design to accommodate the components, such as for optimum sizing and comfort. For example, machine learning training may utilize many examples of correct component placements. A discrete set of possible warnings may be used as outputs, such as for example if a user attempts to constrain a placement that conflicts with the machine learning model's placement. In embodiments, however, absolute parameters may overrule the model, such as defined clearances/thicknesses for component placement.

In embodiments, the machine learning algorithm may be a neural network, may be recursive, may have an architecture defined by matrix equations, or may be initialized with specific randomization techniques (e.g. Xavier, etc.). The machine learning algorithm may learn by back propagation of errors, feedback, iteration, or by providing a known input and a desired output. The machine learning algorithm may improve the model by adjusting weights, rules, parameters, or the like.

In embodiments, the machine learning algorithm may be a classification model. In this model, input data may be labelled manually or automatically, feature image data may be extracted using image processing method and the extracted features may be classified. Then, the model queries a database to determine if the extracted features match stored features, and may implement specific rules based on whether the extracted features match stored features or not.

In embodiments, the machine learning model may be trained to minimize manufacturing cost. The machine learning model may learn to optimize manufacturing cost relevant to fit, performance, and comfort. The machine learning model will learn what trade-offs have been made in the past as revealed by the data it is trained on.

In an embodiment, a fabrication facility for devices based on predicted models may include a 3D printer, SL8 or other printer. For ear-dwelling devices, the fabrication facility may fabricate devices based on 3-D models that were generated by a machine learning model with three-dimensional ear scans as inputs.

In an embodiment, the three-dimensional ear scans may be made with a system that includes a first scanner, wherein the first scanner includes an inflatable membrane configured to be inflated with a medium to conform an exterior surface of the inflatable membrane to an interior shape of a cavity. The medium may attenuate, at a first rate per unit length, light having a first optical wavelength, and attenuate, at a second rate per unit length, light having a second optical wavelength. The scanner may also include an emitter configured to generate light to illuminate the interior surface of the inflatable membrane and a detector configured to receive light from the interior surface of the inflatable membrane. The received light may include light at the first optical wavelength and the second optical wavelength. The scanner may further include a processor configured to generate a first electronic representation of the interior shape based on the received light. The system may include a machine learning design computer configured to transform the first electronic representation into a predicted, three-dimensional shape corresponding to at least a portion of the interior shape. The system may also include a fabricator configured to fabricate, based at least on the predicted, three-dimensional shape or representation, an ear-dwelling device. A user interface may be used to access the system. The user interface may display a scan of the anatomic cavity overlaid with a representation of a custom device designed to be placed in the cavity. The user interface may allow for input of user preferences and constraints prior to transformation by a machine learning model, and may also enable further user-based customization post-transformation.

In an embodiment, the first electronic representation may be stored as an STL file. In embodiments, the STL file may be converted to another format to do training/machine learning transformation. In embodiments, the predicted, three-dimensional shape may be converted back to an STL for fabrication. In embodiments, the STL file may be downsampled to accelerate training, but may be at the cost of detail in the model.

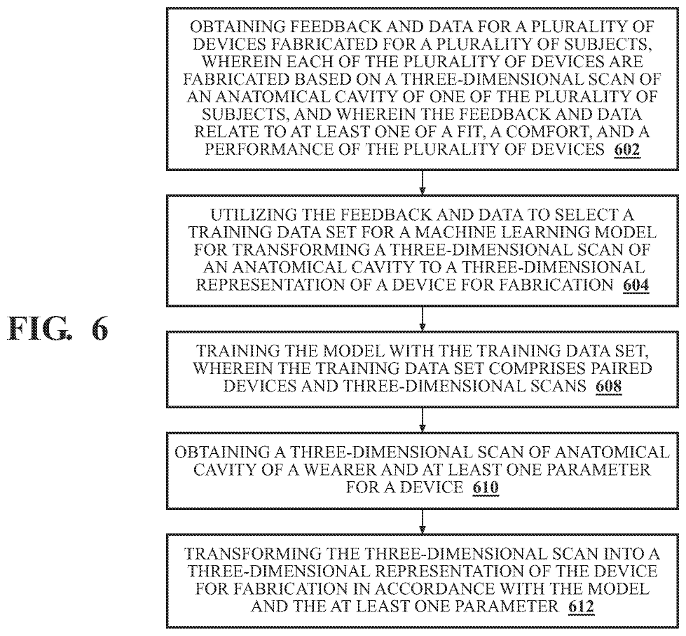

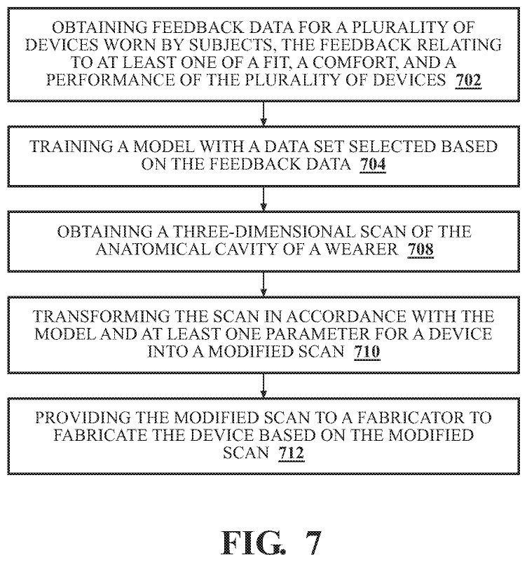

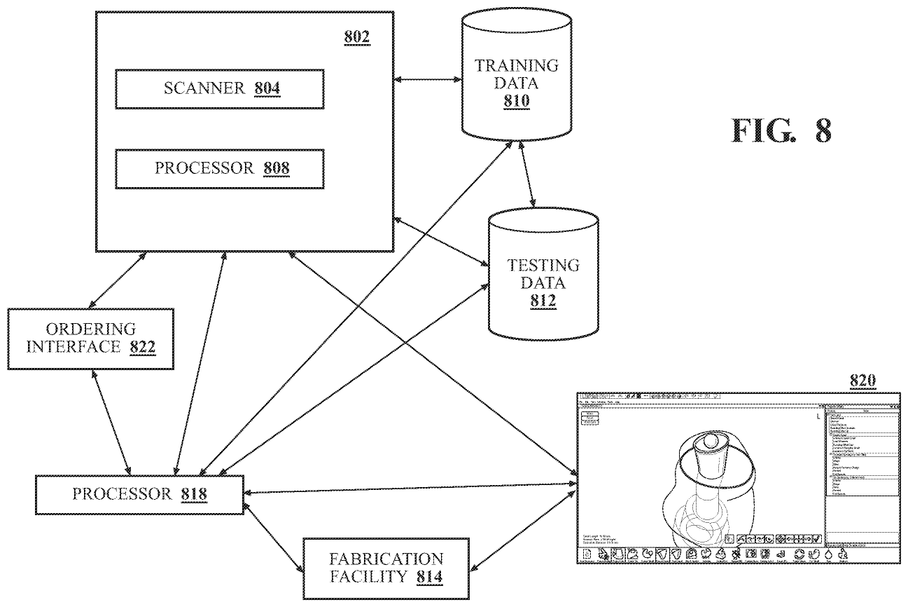

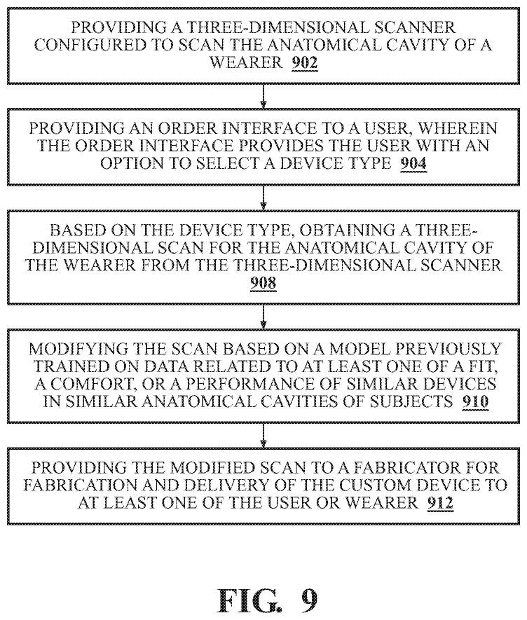

In an aspect, and referring to FIG. 6, a computer-implemented method to create a model used for fabrication of a device configured for placement in an anatomical cavity of a wearer may include first selecting training data. Training data and/or testing data may be selected as described previously herein, such as by obtaining feedback and data, such as performance data, for a plurality of devices fabricated for a plurality of subjects, wherein each of the plurality of devices are fabricated based on a three-dimensional scan of an anatomical cavity of one of the plurality of subjects, and wherein the feedback and data relate to at least one of a fit, a comfort, and a performance of the plurality of devices and then using the obtained data to select a training data set. The training data set is used to train a machine learning model for transforming a three-dimensional scan of an anatomical cavity to a three-dimensional representation of a device for fabrication. The testing data may be used to validate the model. Once the machine learning model is trained, a three-dimensional scan of an anatomical cavity of a wearer can be obtained and at least one parameter for a desired device can be indicated to the machine learning model. The trained machine learning model can then transform the three-dimensional scan into a three-dimensional representation of the device for fabrication in accordance with the model and the at least one parameter. A quality control or verification step may be included to confirm appropriate final shape before fabrication.

In an aspect, a computer-implemented method for fabrication of a device configured for placement in an anatomical cavity of a wearer may include obtaining feedback data for a plurality of devices worn by subjects, the feedback relating to at least one of a fit, a comfort, and a performance of the plurality of devices 702, training a model with a dataset selected based on the feedback data 704, obtaining a three-dimensional scan of the anatomical cavity of a wearer 708, transforming the scan in accordance with the model and at least one parameter for a device into a modified scan 710 and providing the modified scan to a fabricator to fabricate the device based on the modified scan 712.

In an aspect, a system for fabrication of devices designed by a machine learning model based on a cavity scan is shown in FIG. 8. In the user interface 820, a scan of the anatomic cavity overlaid with a representation of a custom device designed to be placed in the cavity is shown. The system may include a processor 818 that trains a machine learning model on datasets 810 selected based on feedback data for a plurality of devices worn by subjects, the feedback relating to a fit, a comfort, or a performance of the plurality of devices; (ii) receives at least one parameter for the custom device; and (iii) receives a three-dimensional scan of the anatomical cavity of a wearer. The three-dimensional scan is acquired by a system 802 that includes a scanner 804 and a processor 808. The processor 818 further comprises stored instructions that when executed cause the processor to generate modifications of the three-dimensional scan to obtain a modified scan, wherein the modifications of the three-dimensional scan are in accordance with the machine learning model and wherein the modifications comprise at least one of adding or reducing dimension of the three-dimensional scan. The processor 818 is further programmed to send the modified scan to a fabrication facility 814 for the fabrication of the custom device based on the modified scan. In certain embodiments, the system may include an ordering interface 822 where a user requests a device and is prompted to then utilize the scanner 804.

In an aspect, an ordering and production system for ordering earpieces may receive an order from a user including a custom scan, manufacturer the earpieces, and deliver the same to the user. A method to fabricate and deliver a custom device to be worn in an anatomical cavity of a wearer may include providing a three-dimensional scanner configured to scan the anatomical cavity of a wearer 902, providing an order interface 822 to a user, wherein the order interface provides the user with an option to select a device type 904, based on the device type, obtaining a three-dimensional scan for the anatomical cavity of the wearer from the three-dimensional scanner 908, modifying the scan based on a model previously trained on data related to at least one of a fit, a comfort, or a performance of similar devices in similar anatomical cavities of subjects 910 and providing the modified scan to a fabricator for fabrication and delivery of the custom device to at least one of the user or wearer 912.

In embodiments, training data for a model and/or algorithm may include one or more vectors of data. The vector of data may include data representative of a scan of a cavity such as an ear cavity. The vector data may further include data representative of a shape or a scan of a device designed to fit the cavity, such as a hearing aid. In some cases, a scan of a hearing aid may be provided, which may be transformed into part of the vector data. In some cases, the vector data may include comparison data that relates to how the hearing aid fits into the ear cavity. For example, in some cases, the vector data may include data related to the relative dimensions of the hearing aid and the ear cavity. In some cases, the vector data may further include data related to the materials, textures, curvature, and the like used in the hearing aid at different locations of the hearing aid. In some cases, the vector data may include data related to the elasticity of the materials at different locations of the hearing aid. In embodiments, any available characteristic of a hearing aid design and any available data related to the scan and characteristics of an ear cavity may be used as inputs for training of a model and/or algorithm.

In embodiments, training vectors of data may further include data related to the performance of the hearing aid in the cavity, user experience, user rating, survey data, and the like. In embodiments, the objective experience of a user wearing a hearing aid may be captured and represented as a vector element in the training data. The training data may include data related to a cavity, data related to a hearing aid, and data related to the rating and performance of the hearing aid with respect to the cavity. In embodiments, thousands or even millions of such data vectors may be used as input data to train a model and/or algorithm. In embodiments, the ratings and the performance of each hearing aid with respect to each cavity may train the model and/or algorithm to determine characteristics that correlate and/or are predictive of acceptable performance, comfort, and/or fit. In embodiments, the ratings and the performance of each hearing aid with respect to each cavity may train the model and/or algorithm to determine characteristics that correlate or are predictive of unacceptable performance, comfort, and/or fit.

In embodiments, the vectors of data may include labels or identifiers for each element of the vector and may be used as inputs for supervised or semi-supervised learning. In some cases, vector data may not include labels, and the vectors may be used as inputs for unsupervised learning algorithms. Any machine learning described herein may receive the described input vectors for training.

The data that is used to train a model and/or algorithm may be a subset of the available data. In some cases, the data may be selected according to the precision of the measured data. Data that is known to not meet the desired precision threshold, for example, may be omitted from the training data.

In some embodiments, after a model and/or algorithm is trained, the model and/or algorithm may receive, as input, data representative of an ear cavity, data related to an existing hearing aid design, and a proposed modification to the existing hearing aid design. Based on the input data, the model and/or algorithm may output data that provides an indication as to whether the proposed design would improve or provide a favorable rating of performance, comfort, and/or fit. In some cases, fitting of a hearing to an individual involves starting with one or more base designs that are modified to fit the needs of specific users. Using the base design, an operator may use a graphical software to visually model how the base design would fit in a person's ear cavity by simultaneously showing a visual model of the hearing aid and a visual model of the ear cavity derived from one or more scans of the person. Software may be used to virtually change the shape of the hearing aid in relation to the unique ear cavity of each person. In such cases, when a change is made in the shape, such as adding extra thickness, changing curvature, sculpting and edge, and the like, the trained model and/or algorithm may be invoked to determine if the new features of the hearing aid may provide improved performance, comfort, and/or fit for the particular person. A trained model and/or algorithms may take as input the changes to the hearing aid, the hearing aid design, and the data related to the ear cavity of the person and provide an output indicating if the changes made to the base hearing aid design appear to provide improved performance, comfort, and/or fit for the particular person. In some cases, feedback may be provided to a user via visual indications during virtual modifications of a base hearing aid design on a computer. In some cases, feedback to a user may be provided in real-time, substantially real, or after invoking a specific command.

In some embodiments, modification to a base hearing aid design may be automatically or semi-automatically generated within the constraints of the ear cavity. In some cases, a series of possible modifications may be virtually applied to a base design of a hearing aid. After each modification, the trained model and/or algorithm may be used to determine if the modified hearing aid is determined or predicted to provide improved performance, comfort, and/or fit for the particular person. In some embodiments, hundreds of thousands of different modifications may be evaluated by the trained model and/or algorithm to determine which changes may offer the greatest improvement over the base hearing aid design.

In some embodiments, after a model and/or algorithm is trained, the model and/or algorithm may be used to take as input data representative of an ear cavity, data related to an existing hearing aid design, and data related to performance, rating, or fit of the existing hearing aid. Using the input data, the model and/or algorithm may provide as output characteristics of changes or optimizations to the hearing aid to provide improved performance, comfort, and/or fit. In some embodiments, a user may have an existing hearing aid which does not provide adequate performance, comfort, and/or fit. In embodiments, the trained model and/or algorithm may be used to determine or identify design or modifications to the existing design that may improve performance, comfort, and/or fit.

In some embodiments, after a model and/or algorithm is trained and validated, the model and/or algorithm may be used to take as input data related to a cavity and provide as output data that may be used to determine characteristics of a device for the cavity that is likely to provide acceptable performance, comfort, and/or fit. In some embodiments, a hearing aid may be designed for a person who has never worn a hearing aid, and no data regarding the person's preferences are available. In such a case, the trained model and/or algorithm may be used to determine a design for the hearing aid. The trained model and/or algorithm may be used to iteratively access designs to identify a design that has desired performance, comfort, and/or fit.

In embodiments, fitting or selecting a hearing aid design may be based on selecting one of a finite number of predefined hearing aid designs. In some cases, a finite number, such as ten or more, a hundred or more, or even a thousand or more different hearing aid designs may be available. Each hearing design may be having a different shape, size, length, materials, and the like. In this scenario, fitting of a hearing aid may be based on a scan of the ear cavity of the person. In some cases, fitting of hearing aid may also be based on user preferences such as comfort, ease of insertion and removal, device retention, and oscillatory feedback, amplification performance, and the like. In some cases, fitting of hearing aid may also be based on additional data such as age, gender, degree of hearing loss, medical conditions, dexterity, and the like.

In embodiments, training data for a model and/or algorithm may include one or more vectors of data representative of a scan of a cavity such as an ear cavity. The vector data may further include data representative of a rating or feedback received from the person with respect to one or more different hearing aid designs. In some cases, a user may try two or more, or even a hundred different hearing aids and report on the comfort, performance, ease of use, fit, and the like. The feedback from the user may be a numerical rating of the absolute or relative performance of the hearing aid. The user feedback and ratings may be captured in the training vector along with any additional characteristics of the person that provided the ratings, such as the age, gender, medical conditions, and the like.

After a model and/or algorithm is trained, the model and/or algorithm may be used to take as input data representative of an ear cavity of a person and optionally additional data related to the gender, health, age and the like of the person. Using the input data, the model and/or algorithm may provide as output data that may be used to select one or more appropriate hearing aids from the set of pre-existing hearing aids. The trained model and/or algorithm may be used to identify hearing aid designs that other people with similar ear cavity shapes and personal traits found to be highly rated in terms of comfort, fit, performance, and the like.

In embodiments, after one or more hearing aid designs are selected by the trained model and/or algorithm, the user may try some of the designs and provide a rating related to one or more criteria. The rating and data may be used to further train and refine the model and/or algorithm. In some embodiments, after one or more hearing aid designs are selected by the trained model and/or algorithm, the designs may be further manually modified to fit the requirements of the person.

In embodiments, different learning models and/or algorithms may be trained to determine designs for different parts of a hearing aid and/or for different portions of a cavity.

A cavity such as an ear cavity may include two or more distinct areas or portions. In some cases, different sections of a cavity may include different curvature, tissue elasticity, perform different functions, and the like. In one example of an ear cavity, one area may be the concha cavity just behind the tragus, which is relatively large and is surrounded by cartilaginous tissue. A second cavity section, medial to the aperture of the external acoustic meatus, is generally smaller and is also surrounded by cartilaginous tissue. A third cavity section may be the final canal segment near the tympanic membrane. In some embodiments, different machine learning models and/or algorithms may be used to determine the characteristics of the device that fits the respective areas of the cavity. In embodiments, different models and/or algorithms may be used for the top and bottom of a cavity, the sides of a cavity, and/or based on the depth of the cavity.

A hearing aid may include two or more distinct portions or sections. In some embodiments, different machine learning models and/or algorithms may be used to determine the characteristics of different portions of the hearing aid. For example, some portions of the hearing aid's main function may be to provide a tight fit within the cavity versus other sections of the hearing aid may be shaped with additional considerations to optimize energy transfer, acoustics, frequency response, and the like. The device/scan may be segmented into different parts, and each part may be associated with a different training set and learning algorithm and/or model.

In embodiments, a cavity and/or a device may be logically divided into separate areas or functions and different models and/or algorithms used to determine the characteristics of the different areas. In embodiments separating a cavity and/or a hearing device into different areas and using different models and/or algorithms to determine characteristics of an area may improve the accuracy of the models and/or algorithms. Ins some cases, training algorithms and/or models on smaller portions may involve fewer parameters and/or variables as inputs. In some cases, a model that is trained on fewer variables or inputs of the system may provide more accurate or predictable outputs with respect to the inputs than a model or algorithm that is trained on all the parameters and variables of a system. For example, in the case of a hearing aid, different portions of a hearing aid may be associated with different variables and/or parameters that may not be associated with one another.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions, and the like. The processor may be or may include a signal processor, digital processor, embedded processor, microprocessor, or any variant such as a co-processor (math co-processor, graphic co-processor, communication co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions, and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions, and programs as described herein and elsewhere. The processor may access a non-transitory storage medium through an interface that may store methods, codes, and instructions as described herein and elsewhere. The storage medium associated with the processor for storing methods, programs, codes, program instructions, or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code, and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client, and other variants such as secondary client, host client, distributed client, and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of a program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

In embodiments, one or more of the controllers, circuits, systems, data collectors, storage systems, network elements, or the like as described throughout this disclosure may be embodied in or on an integrated circuit, such as an analog, digital, or mixed signal circuit, such as a microprocessor, a programmable logic controller, an application-specific integrated circuit, a field programmable gate array, or other circuit, such as embodied on one or more chips disposed on one or more circuit boards, such as to provide in hardware (with potentially accelerated speed, energy performance, input-output performance, or the like) one or more of the functions described herein. This may include setting up circuits with up to billions of logic gates, flip-flops, multiplexers, and other circuits in a small space, facilitating high speed processing, low power dissipation, and reduced manufacturing cost compared with board-level integration. In embodiments, a digital IC, typically a microprocessor, digital signal processor, microcontroller, or the like may use Boolean algebra to process digital signals to embody complex logic, such as involved in the circuits, controllers, and other systems described herein. In embodiments, a data collector, an expert system, a storage system, or the like may be embodied as a digital integrated circuit (“IC”), such as a logic IC, memory chip, interface IC (e.g., a level shifter, a serializer, a deserializer, and the like), a power management IC and/or a programmable device; an analog integrated circuit, such as a linear IC, RF IC, or the like, or a mixed signal IC, such as a data acquisition IC (including A/D converters, D/A converter, digital potentiometers) and/or a clock/timing IC.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements. The methods and systems described herein may be configured for use with any kind of private, community, or hybrid cloud computing network or cloud computing environment, including those which involve features of software as a service (“SaaS”), platform as a service (“PaaS”), and/or infrastructure as a service (“IaaS”).

The methods, program codes, and instructions described herein and elsewhere may be implemented on a cellular network having multiple cells. The cellular network may either be frequency division multiple access (“FDMA”) network or code division multiple access (“CDMA”) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (“RAM”); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the Figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure, and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

Any element in a claim that does not explicitly state “means for” performing a specified function, or “step for” performing a specified function, is not to be interpreted as a “means” or “step” clause as specified in 35 U.S.C. § 112(f). In particular, any use of “step of” in the claims is not intended to invoke the provision of 35 U.S.C. § 112(f).

Persons skilled in the art may appreciate that numerous design configurations may be possible to enjoy the functional benefits of the inventive systems. Thus, given the wide variety of configurations and arrangements of embodiments of the present invention, the scope of the invention is reflected by the breadth of the claims below rather than narrowed by the embodiments described above.

What is claimed is:

1. A computer-implemented method to create a model used for fabrication of a device configured for placement in an anatomical cavity of a wearer, the method comprising:
(a) obtaining feedback data for a plurality of devices fabricated for a plurality of subjects, wherein each of the plurality of devices are fabricated based on a three-dimensional scan of an anatomical cavity of one of the plurality of subjects, and wherein the feedback data relates to at least one of a user experience, a fit, a comfort, and a performance of the plurality of devices;
(b) utilizing the feedback data to select a training data set for a model for transforming a three-dimensional scan of an anatomical cavity to a three-dimensional representation of a device for fabrication;
(c) training the model with the training data set, wherein the training data set comprises devices paired with three-dimensional scans upon which the devices were based;
(d) obtaining a three-dimensional scan of an anatomical cavity of a wearer and at least one parameter for a device; and
(e) transforming the three-dimensional scan into a three-dimensional representation of the device for fabrication in accordance with the model and the at least one parameter.

2. The method of claim 1, wherein transforming at least one of adds dimension or reduces dimension of a portion of the three-dimensional scan.

3. The method of claim 1, wherein the model is a neural network.

4. The method of claim 1, wherein the anatomical cavity is an ear.

5. The method of claim 1, wherein the device is an in-ear device.

6. The method of claim 1, further comprising, wherein the feedback data are further utilized to select a testing data set for the model, and testing the model with the testing data set.

7. The method of claim 1, wherein the three-dimensional scan is in a first format and is converted to a second format to do modeling.

8. The method of claim 7, wherein at completion of modeling, the three-dimensional representation is converted back to the first format prior to fabrication.

9. The method of claim 1, wherein the three-dimensional representation is an STL file.

10. A computer-implemented method for fabrication of a device configured for placement in an anatomical cavity of a wearer, the method comprising:
(a) obtaining feedback data for a plurality of devices worn by subjects, the feedback data relating to at least one of a user experience, a fit, a comfort, and a performance of the plurality of devices;
(b) training a model with a dataset selected based on the feedback data;
(c) obtaining a three-dimensional scan of the anatomical cavity of a wearer;
(d) transforming the three-dimensional scan in accordance with the model and at least one parameter for a device into a modified scan; and
(e) providing the modified scan to a fabricator to fabricate the device based on the modified scan.

11. A system to fabricate a custom device to be worn in an anatomical cavity of a wearer, the system comprising:
a processor that: (i) trains a machine learning model on datasets selected based on feedback data for a plurality of devices worn by subjects, the feedback relating to a user experience, a fit, a comfort, or a performance of the plurality of devices; (ii) receives at least one parameter for the custom device; and (iii) receives a three-dimensional scan of the anatomical cavity of a wearer, the processor further comprising stored instructions that when executed cause the processor to:
generate modifications of the three-dimensional scan to obtain a modified scan, wherein the modifications of the three-dimensional scan are in accordance with the machine learning model and wherein the modifications comprise at least one of adding or reducing dimension of the three-dimensional scan.

12. The system of claim 11, wherein the processor is further programmed to send the modified scan to a fabricator for fabrication of the custom device.

13. The system of claim 11, further comprising, a user interface to provide input to the system.

14. The system of claim 11, wherein a fabricator fabricates the custom device based on the modified scan.

15. The system of claim 11, wherein the anatomical cavity of the wearer is an ear.

16. The system of claim 11, wherein the custom device is an in-ear device.

17. A method to fabricate and deliver a custom device to be worn in an anatomical cavity of a wearer, the method comprising:
(a) providing a three-dimensional scanner configured to scan the anatomical cavity of a wearer;
(b) providing an order interface to a user, wherein the order interface provides the user with an option to select a device type;
(c) based on the device type, obtaining a three-dimensional scan for the anatomical cavity of the wearer from the three-dimensional scanner;
(d) modifying the scan based on a model previously trained on data related to at least one of a fit, a comfort, or a performance of similar devices in similar anatomical cavities of subjects; and
(e) providing the modified scan to a fabricator for fabrication and delivery of the custom device to at least one of the user or wearer.

18. A computer-implemented method to determine a device design for placement in a cavity, the method comprising:
(a) obtaining feedback data from a user for a device, wherein the feedback data relates to at least one of a user experience, a fit, a comfort, and a performance of the device;
(b) obtaining a three-dimensional scan of an anatomical cavity of the user;
(c) generating a training vector, wherein the training vector includes: the feedback data, the three-dimensional scan, and an identification of the device;
(d) training a model using the training vector;
(e) obtaining three-dimensional scans of an anatomical cavity of a second user;
(f) providing the three-dimensional scan of the anatomical cavity of the second user to the model; and
(g) receiving, from the model, data indicative of a selected design of a device for the second user.

19. The method of claim 18, wherein training the model further comprises training the model using a plurality of training vectors corresponding to feedback data and three dimensional scans from a plurality of users.

20. A computer-implemented method to determine a device design for placement in a cavity, the method comprising:
(a) obtaining a three-dimensional scan of an anatomical cavity of a user;
(b) obtaining a three-dimensional data of a device that is placed in the anatomical cavity of the user;
(c) obtaining feedback data from a user for a device, wherein the feedback data relates to at least one of a user experience, a fit, a comfort, and a performance of the device;
(d) generating a training vector, wherein the training vector includes: the feedback data, the three-dimensional scan, and the three-dimensional data of the device;
(e) training a model using the training vector;
(f) obtaining a three-dimensional scan of an anatomical cavity of a second user;
(g) obtaining a design data of base device design;
(h) receive a modification to the base device design;
(i) providing to the model: the three-dimensional scan of the anatomical cavity of the second user to the model, data representative of the base device design, and the modification to the base device design; and
(j) receiving, from the model, data indicative of a predictive rating of the modification to the base device design for the second user.
